(19) United States
(12) Patent Application Publication
(10) Pub. No.: US 2016/0306758 A1
(43) Pub. Date: Oct. 20, 2016

(54) PROCESSING SYSTEM HAVING KEYWORD RECOGNITION SUB-SYSTEM WITH OR WITHOUT DMA DATA TRANSACTION

(71) Applicant: MEDIATEK INC., Hsin-Chu (TW)

(72) Inventors: Chia-Hsien LU, New Tapei City (TW); Chih-Ping LIN, Hsinchu County (TW)

(21) Appl. No.: 14/906,554

(22) PCT Filed: Nov. 5, 2015
(86) PCT No.: PCT/CN2015/093882

§ 371 Date: Jan. 21, 2016

Related U.S. Application Data
(60) Provisional application No. 62/076,144, filed on Nov. 6, 2014.

(51) Int. Cl. G06F 13/28; G06F 3/16

(52) U.S. Cl. CPC G06F 13/28; G06F 3/165

(57) ABSTRACT

A processing system has a keyword recognition sub-system and a direct memory access (DMA) controller. The keyword recognition sub-system has a processor and a local memory device. The processor performs at least keyword recognition. The local memory device is accessible to the processor and is arranged to buffer at least data needed by the keyword recognition. The DMA controller interfaces between the local memory device of the keyword recognition sub-system and an external memory device, and is arranged to perform DMA data transaction between the local memory device and the external memory device.

### CROSS REFERENCE TO RELATED APPLICATIONS

This application claims the benefit of U.S. provisional application No.62/076,144, filed on Nov. 6, 2014 and incorporated herein by reference.

### TECHNICAL FIELD

The disclosed embodiments of the present invention relate to a keyword recognition technique, and more particularly, to a processing system having a keyword recognition sub-system with/without direct memory access (DMA) data transaction for achieving certain features such as multi-keyword recognition, concurrent application use (e.g., performing audio recording and keyword recognition concurrently), continuous voice command and/or echo cancellation.

### BACKGROUND

One conventional method of searching a voice input for certain keyword(s) may employ a keyword recognition technique. For example, after a voice input is received, a keyword recognition function is operative to perform a keyword recognition process upon the voice input to determine whether at least one predefined keyword can be found in the voice input being checked. The keyword recognition can be used to realize a voice wakeup function. For example, a voice input may come from a handset's microphone and/or a headphone's microphone. After a predefined keyword is identified in the voice input, the voice wakeup function can wake up a processor and, for example, automatically launch an application (e.g., a voice assistant application) on the processor.

If there is a need to perform keyword recognition with additional features such as multi-keyword recognition, concurrent application use, continuous voice command and/or echo cancellation, the hardware circuit and/or software module, however, should be properly designed in order to achieve the desired functionality.

### SUMMARY

In accordance with exemplary embodiments of the present invention, a processing system having a keyword recognition sub-system with/without direct memory access (DMA) for achieving certain features such as multi-keyword recognition, concurrent application use (e.g., performing audio recording and keyword recognition concurrently), continuous voice command and/or echo cancellation is proposed.

According to a first aspect of the present invention, an exemplary processing system is disclosed. The exemplary processing system includes a keyword recognition sub-system and a direct memory access (DMA) controller. The keyword recognition sub-system has a processor arranged to perform at least keyword recognition; and a local memory device accessible to the processor and arranged to buffer at least data needed by the keyword recognition. The DMA controller interfaces between the local memory device of the keyword recognition sub-system and an external memory device, and is arranged to perform DMA data transaction between the local memory device and the external memory device.

According to a second aspect of the present invention, an exemplary processing system is disclosed. The exemplary processing system includes a keyword recognition sub-system having a processor and a local memory device. The processor is arranged to perform at least keyword recognition. The local memory device is accessible to the processor, wherein the local memory device is arranged to buffer data needed by the keyword recognition and data needed by an application.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a processing system according to an embodiment of the present invention.

FIG. 2 is a diagram illustrating another processing system according to an embodiment of the present invention.

FIG. 3 is a diagram illustrating an operational scenario in which the keyword recognition sub-system in FIG. 2 may be configured to achieve multi-keyword recognition according to an embodiment of the present invention.

FIG. 4 is a diagram illustrating a comparison between keyword recognition with processor-based keyword model exchange and keyword recognition with DMA-based keyword model exchange according to an embodiment of the present invention.

FIG. 5 is a diagram illustrating an operational scenario in which the keyword recognition sub-system in FIG. 2 may be configured to achieve concurrent application use (e.g. performing audio recording and keyword recognition concurrently) according to an embodiment of the present invention.

FIG. 6 is a diagram illustrating an operational scenario in which the keyword recognition sub-system in FIG. 2 may be configured to achieve continuous voice command according to an embodiment of the present invention.

FIG. 7 is a diagram illustrating an operational scenario in which the keyword recognition sub-system in FIG. 2 may be configured to achieve keyword recognition with echo cancellation according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

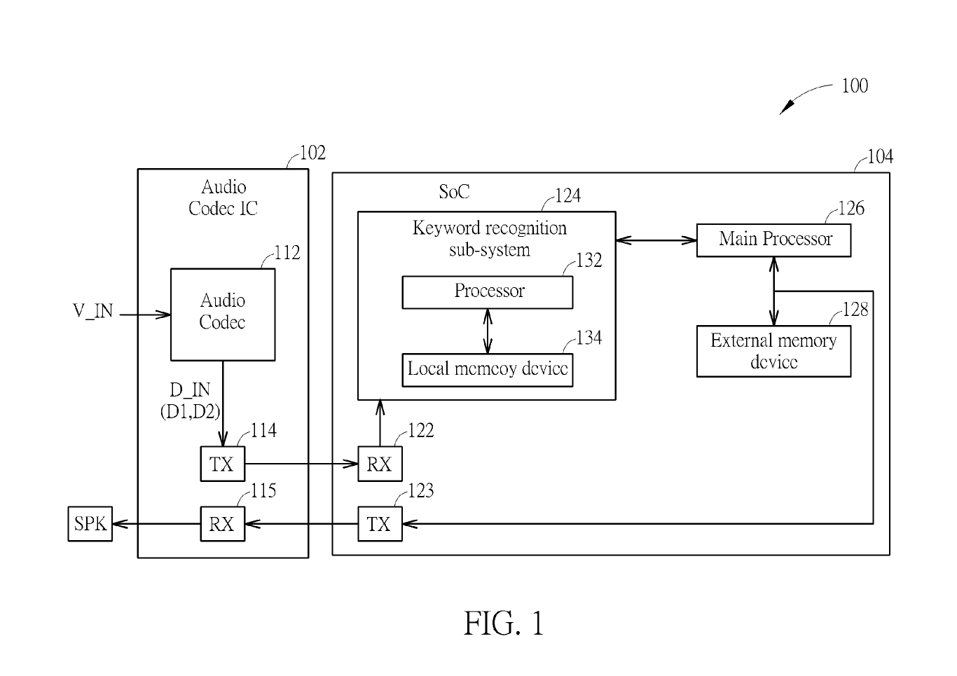

FIG. 1 is a diagram illustrating a processing system according to an embodiment of the present invention. In this embodiment, the processing system 100 may have independent chips, including an audio coder/decoder (Codec) integrated circuit (IC) 102 and a System-on-Chip (SoC) 104. However, this is for illustrative purposes only, and is not meant to be a limitation of the present invention. In an alternative design, circuit components in audio Codec IC 102 and SoC 104 may be integrated in a single chip. As shown in FIG. 1, the audio Codec IC 102 may include an audio Codec 112, a transmit (TX) circuit 114 and a receive (RX) circuit 115. A voice input V_IN may be generated from an audio source such as a handset's microphone or a headphone's microphone. The audio Codec 112 may convert the voice input V_IN into an audio data input (e.g., pulse-code modulation data) D_IN for further processing in the following stage (e.g., SoC 104),In one exemplary embodiment, the audio data input D_IN may include one audio data D1 to be processed by the keyword recognition. In another exemplary embodiment, the audio data input D_IN may include one audio data D1 to be processed by the keyword recognition running on the processor 132, and may further include one subsequent audio data (e.g., audio data D2) to be processed by an application running on the main processor 126.

The SoC 104 may include an RX circuit 122, a TX circuit 123, a keyword recognition sub-system 124, a main processor 126, and an external memory device 128. With regard to the keyword recognition sub-system 124, it may include a processor 132 and a local memory device 134. For example, the processor 132 may be a tiny processor (e.g., an ARM-based processor or a 8051-based processor) arranged to perform at least the keyword recognition, and the local memory device 134 may be an internal memory (e.g., a static random access memory (SRAM)) accessible to the processor 132 and arranged to buffer one or both of data needed by keyword recognition and data needed by an application. The external memory device 128 can be any memory device external to the keyword recognition sub-system 124, any memory device different from the local memory device 134, and/or any memory device not directly accessible to the processor 132. For example, the external memory device 128 may be a main memory (e.g., a dynamic random access memory (DRAM)) accessible to the main processor 126 (e.g., an application processor (AP)). The local memory device 134 may be located inside or outside the processor 132. The processor 132 may issue an interrupt signal to the main processor 126 to notify the main processor 126. For example, the processor 132 may notify the main processor 126 upon detecting a pre-defined keyword in the audio data D1.

In this embodiment, the processing system 100 may have two chips including audio Codec IC 102 and SoC 104. Hence, the TX circuit 114 and the RX circuit 122 may be paired to serve as one communication interface between audio Codec IC 102 and SoC 104, and may be used to transmit the at least one audio data D IN derived from the audio input V_IN from the audio Codec IC 102 to the SoC 104. In addition, the TX circuit 123 and the RX circuit 115 may be paired to serve as another communication interface between audio Codec IC 102 and SoC 104, and may be used to transmit an audio playback data generated by the main processor 126 from the SoC 104 to the audio Codec IC 102 for audio playback via an external speaker SPK driven by the audio Codec IC 102.

In a case where the keyword recognition sub-system 124 may be configured to achieve multi-keyword recognition, a first solution may increase a memory size of the local memory device 134 to ensure that the local memory device 134 can be large enough to buffer data needed by the multi-keyword recognition at the same time. For example, the data needed by the multi-keyword recognition may include an audio data D1 derived from the voice input V_IN and an auxiliary data not derived from the voice input V_IN (e.g., a plurality of keyword models involved in the multi-keyword recognition) buffered in the local memory device 134 at the same time. Hence, the processor 132 may compare the audio data D1 with a first keyword model of the keyword models buffered in the local memory device 134 to determine if the audio data D1 may contain a first keyword defined in the first keyword model. Next, the processor 132 may compare the same audio data D1 with a second keyword model of the keyword models buffered in the local memory device 134 to determine if the audio data D1 may contain a second keyword defined in the second keyword model. Since all of the keyword models needed by the multi-keyword recognition may be held in the same local memory device 134, the keyword model exchange may be performed on the local memory device 134 directly.

In a case where the keyword recognition sub-system 124 may be configured to achieve multi-keyword recognition, a second solution may notify the main processor 126 to deal with at least a portion of the data needed by the multi-keyword recognition, during the keyword recognition being performed by the processor 132. For example, during the keyword recognition being performed by the processor 132, the processor 132 may notify (e.g., wake up) the main processor 126 to deal with keyword model exchange for multi-keyword recognition. At least a portion of the keyword models needed by the multi-keyword recognition may be stored in the external memory device 128 at the same time. The processor 132 may compare the audio data D1 with a first keyword model currently buffered in the local memory device 134 to determine if the audio data D1 may contain a first keyword defined in the first keyword model. Next, the processor 132 may notify (e.g., wake up) the main processor 126 to load a second keyword model into the local memory device 134 from the external memory device 128 to thereby replace the first keyword model with the second keyword model, and may compare the same audio data D1 with the second keyword model currently buffered in the local memory device 134 to determine if the audio data D1 may contain a second keyword defined in the second keyword model. Since all of the keyword models needed by the multi-keyword recognition may not be held by the local memory device 134 at the same time, the keyword model exchange may be performed through the main processor 126 on behalf of the processor 132.

In a case where the keyword recognition sub-system 124 may be configured to achieve multi-keyword recognition, a third solution may use the processor 132 to access the external memory device 128 to deal with at least a portion of the data needed by the multi-keyword recognition, during the keyword recognition being performed by the processor 132. For example, during the keyword recognition being performed by the processor 132, the processor 132 may access the external memory device 128 to deal with keyword model exchange for multi-keyword recognition. At least a portion of the keyword models needed by the multi-keyword recognition may be stored in the external memory device 128 at the same time. The processor 132 may compare the audio data D1 with a first keyword model currently buffered in the local memory device 134 to determine if the audio data D1 may contain a first keyword defined in the first keyword model. Next, the processor 132 may access the external memory device 128 to load a second keyword model into the local memory device 134 from the external memory device 128 to thereby replace the first keyword model with the second keyword model, and may compare the same audio data D1 with the second keyword model currently buffered in the local memory device 134 to determine if the audio data D1 may contain a second keyword defined in the second keyword model. Since all of the keyword models needed by the multi-keyword recognition may not be held by the local memory device 134 at the same time, the keyword model exchange may be performed by the processor 132 accessing the external memory device 128.

In a case where the keyword recognition sub-system 124 may be configured to achieve concurrent application use (e.g., performing audio recording and keyword recognition concurrently, performing audio playback and keyword recognition concurrently, performing phone call and keyword recognition concurrently, and/or performing VoIP and keyword recognition concurrently), a first solution may increase a memory size of the local memory device 134 to ensure that the local memory device 134 can be large enough to buffer data needed by keyword recognition and data needed by an application at the same time, where the data needed by the keyword recognition may include an audio data D1 derived from the voice input V_IN and an auxiliary data not derived from the voice input V_IN (e.g., at least one keyword model), and the data needed by the application may include a subsequent audio data (e.g., audio data D2) derived from the voice input V_IN. For example, a user may speak a keyword and then may keep talking. The spoken keyword may be required to be recognized by the keyword recognition function for launching an audio recording application, and the subsequent speech content may be required to be recorded by the launched audio recording application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the audio data D2 following the audio data D1 may be buffered in the large-sized local memory device 134. The processor 132 may refer to a keyword recognition result generated for the audio data D1 to selectively notify (e.g., wake up) the main processor 126 to perform audio recording upon the audio data D2 also buffered in the local memory device 134.

In a case where the keyword recognition sub-system 124 may be configured to achieve concurrent application use, a second solution may notify the main processor 126 to deal with the data needed by the application, during the keyword recognition being performed by the processor 132. For example, during the keyword recognition being performed by the processor 132, the processor 132 may notify (e.g., wake up) the main processor 126 to capture the audio data D2 for later audio recording. For example, a user may speak a keyword and then may keep talking. The spoken keyword may be required to be recognized by the keyword recognition function for launching an audio recording application, and the subsequent speech content may be required to be recorded by the launched audio recording application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the processor 132 may notify (e.g., wake up) the main processor 126 to capture the audio data D2 following the audio data D1 and store the audio data D2 into the external memory device 128. The processor 132 may refer to a keyword recognition result generated for the audio data D1 to selectively notify the main processor 126 to perform audio recording upon the audio data D2 buffered in the external memory device 128.

In a case where the keyword recognition sub-system 124 may be configured to achieve concurrent application use, a third solution may use the processor 132 to access the external memory device 128 to deal with at least a portion of the data needed by the application, during the keyword recognition being performed by the processor 132. For example, during the keyword recognition being performed by the processor 132, the processor 132 may write the audio data D2 into the external memory device 128 for later audio recording. For example, a user may speak a keyword and then may keep talking. The spoken keyword may be required to be recognized by the keyword recognition function for launching an audio recording application, and the subsequent speech content may be required to be recorded by the launched audio recording application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the processor 132 may access the external memory device 128 to store the audio data D2 following the audio data D1 into the external memory device 128. The processor 132 may refer to a keyword recognition result generated for the audio data D1 to selectively notify(e.g., wake up) the main processor 126 to perform audio recording upon the audio data D2 buffered in the external memory device 128.

In a case where the keyword recognition sub-system 124 may be configured to achieve continuous voice command, a first solution may increase a memory size of the local memory device 134 to ensure that the local memory device 134 can be large enough to buffer data needed by keyword recognition and data needed by voice command at the same time, where the data needed by the keyword recognition may include an audio data D1 derived from the voice input V_IN and an auxiliary data not derived from the voice input V_IN (e.g., at least one keyword model), and the data needed by voice command may include a subsequent audio data (e.g., audio data D2) derived from the voice input V_IN. For example, a user may speak a keyword and then may keep speaking at least one voice command. The spoken keyword may be required to be recognized by the keyword recognition function for launching a voice assistant application, and the subsequent voice command(s) may be required to be handled by the launched voice assistant application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the audio data D2 following the audio data D1 may be buffered in the large-sized local memory device 134. The processor 132 may refer to a keyword recognition result generated for the audio data D1 to selectively notify (e.g., wake up) the main processor 126 to perform voice command execution based on the audio data D2 buffered in the local memory device 134.

In a case where the keyword recognition sub-system 124 may be configured to achieve continuous voice command, a second solution may notify the main processor 126 to deal with the data needed by the application, during the keyword recognition being performed by the processor 132. For example, during the keyword recognition being performed by the processor 132, the processor 132 may notify (e.g., wake up) the main processor 126 to capture the audio data D2 for later voice command execution. For example, a user may speak a keyword and then may keep speaking at least one voice command. The spoken keyword may be required to be recognized by the keyword recognition function for launching a voice assistant application, and the subsequent voice command(s) may be required to be handled by the launched voice assistant application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the processor 132 may notify (e.g., wake up) the main processor 126 to capture the audio data D2 following the audio data D1 and store the audio data D2 into the external memory device 128. The processor 132 may refer to a keyword recognition result generated for the audio data D1 to selectively notify the main processor 126 to perform voice command execution based on the audio data D2 buffered in the external memory device 128.

In a case where the keyword recognition sub-system 124 may be configured to achieve continuous voice command, a third solution may use the processor 132 to access the external memory device 128 to deal with at least a portion of the data needed by the application, during the keyword recognition being performed by the processor 132. For example, during the keyword recognition being performed by the processor 132, the processor 132 may write the audio data D2 into the external memory device 128 for later voice command execution. For example, a user may speak a keyword and then may keep speaking at least one voice command. The spoken keyword may be required to be recognized by the keyword recognition function for launching a voice assistant application, and the subsequent voice command(s) may be required to be handled by the launched voice assistant application. Hence, the processor 132 may compare the audio data D1 with a keyword model buffered in the local memory device 134 to determine if the audio data D1 may contain a keyword defined in the keyword model. While the processor 132 is performing keyword recognition upon the received audio data D1, the processor 132 may access the external memory device 128 to store the audio data D2 following the audio data D1 into the external memory device 128. The processor 132 may refer to a keyword recognition result generated for the audio data D1 to selectively notify (e.g., wake up) the main processor 126 to perform voice command execution based on the audio data D2 buffered in the external memory device 128.

In a case where the keyword recognition sub-system 124 may be configured to achieve keyword recognition with echo cancellation, a first solution may increase a memory size of the local memory device 134 to ensure that the local memory device 134 can be large enough to buffer data needed by keyword recognition at the same time, where the data needed by the keyword recognition may include an audio data D1 derived from the voice input V_IN and an auxiliary data not derived from the voice input V_IN (e.g., an echo reference data involved in keyword recognition with echo cancellation) buffered in the local memory device 134 at the same time. For example, an audio playback data may be generated from the main processor 126 while audio playback is performed via the external speaker SPK, and the main processor 126 may store the audio playback data into the local memory device 134, directly or indirectly, to serve as the echo reference data needed by echo cancellation. Hence, the processor 132 may refer to the echo reference data buffered in the local memory device 134 to compare the audio data D1 with a keyword model also buffered in the local memory device 134 for determining if the audio data D1 may contain a keyword defined in the keyword model.

In this case, the operation of storing the audio playback data into the local memory device 134 may be performed in a direct manner or an indirect manner, depending upon actual design considerations. For example, when the direct manner may be selected, the echo reference data stored in the local memory device 134 may be exactly the same as the audio playback data. For another example, when the indirect manner may be selected, the operation of storing the audio playback data into the local memory device 134 may include certain audio data processing such as format conversion used to adjust, for example, a sampling rate and/or bits/channels per sample. Hence, the echo reference data stored in the local memory device 134 may be a format conversion result of the audio playback data.

In a case where the keyword recognition sub-system 124 may be configured to achieve keyword recognition with echo cancellation, a second solution may notify the main processor 126 to deal with at least a portion of the data needed by keyword recognition with echo cancellation, during the keyword recognition being performed by the processor 132. For example, an audio playback data may be generated from the main processor 126 while audio playback is performed via the external speaker SPK, and the main processor 126 may store the audio playback data into the external memory device 128, directly or indirectly, to serve as the echo reference data needed by echo cancellation. During the keyword recognition being performed by the processor 132, the processor 132 may notify(e.g., wake up) the main processor 126 to load the echo reference data into the local memory device 134 from the external memory device 128. Hence, the processor 132 may refer to the echo reference data buffered in the local memory device 134 to compare the audio data D1 with a keyword model also buffered in the local memory device 134 for determining if the audio data D1 may contain a keyword defined in the keyword model.

In this case, the operation of storing the audio playback data into the external memory device 128 may be performed in a direct manner or an indirect manner, depending upon actual design considerations. For example, when the direct manner may be selected, the echo reference data stored in the external memory device 128 may be exactly the same as the audio playback data. For another example, when the indirect manner may be selected, the operation of storing the audio playback data into the external memory device 128 may include certain audio data processing such as format conversion used to adjust, for example, a sampling rate and/or bits/channels per sample. Hence, the echo reference data stored in the external memory device 128 may be a format conversion result of the audio playback data.

In a case where the keyword recognition sub-system 124 may be configured to achieve keyword recognition with echo cancellation, a third solution may use the processor 132 to access the external memory device 128 to deal with at least a portion of the data needed by the keyword recognition with echo cancellation, during the keyword recognition being performed by the processor 132. For example, an audio playback data may be generated from the main processor 126 while audio playback is performed via the external speaker SPK, and the main processor 126 may store the audio playback data into the external memory device 128, directly or indirectly, to serve as the echo reference data needed by echo cancellation. During the keyword recognition being performed by the processor 132, the processor 132 may load the echo reference data into the local memory device 134 from the external memory device 128. Hence, the processor 132 may refer to the echo reference data buffered in the local memory device 134 to compare the audio data D1 with a keyword model also buffered in the local memory device 134 for determining if the audio data D1 may contain a keyword defined in the keyword model.

In this case, the operation of storing the audio playback data into the external memory device 128 may be performed in a direct manner or an indirect manner, depending upon actual design considerations. For example, when the direct manner may be selected, the echo reference data stored in the external memory device 128 may be exactly the same as the audio playback data. For another example, when the indirect manner may be selected, the operation of storing the audio playback data into the external memory device 128 may include certain audio data processing such as format conversion used to adjust, for example, a sampling rate and/or bits/channels per sample. Hence, the echo reference data stored in the external memory device 128 may be a format conversion result of the audio playback data.

The processing system 100 may employ one of the aforementioned solutions or may employ a combination of the aforementioned solutions. With regard to any of the aforementioned features (e.g., multi-keyword recognition, concurrent application use, continuous voice command and keyword recognition with echo cancellation), the first solution may require the local memory device 134 to have a larger memory size, and may not be a cost-effective solution. The second solution may require the main processor 126 to be active, and may not be a power-efficient solution. The third solution may require the processor 132 to access the external memory device 128, and may not be a power-efficient solution. The present invention may further propose a low-cost and low-power solution for any of the aforementioned features (e.g., multi-keyword recognition, concurrent application use, continuous voice command and keyword recognition with echo cancellation) by incorporating a direct memory access (DMA) technique.

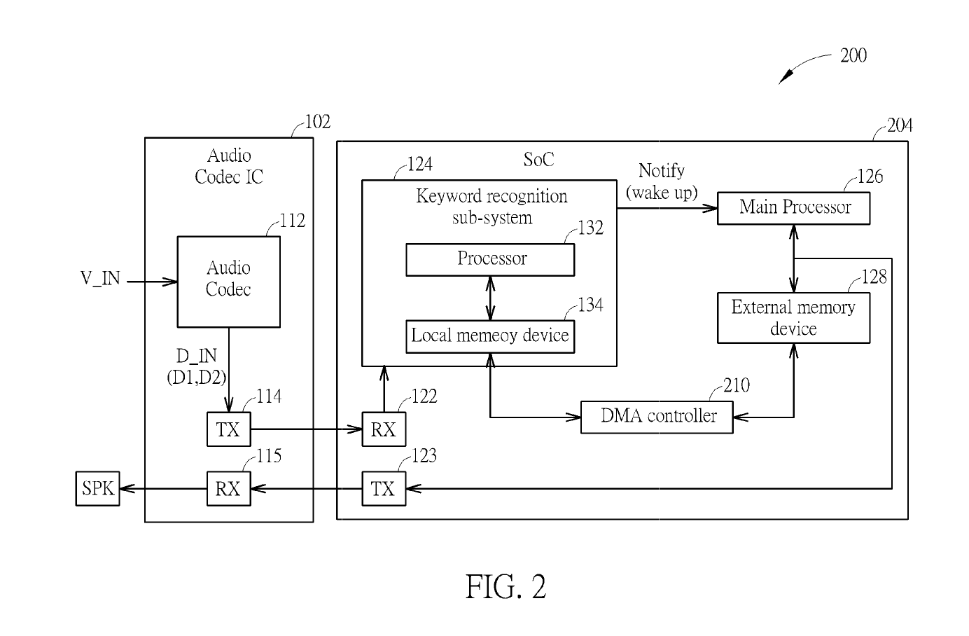

FIG. 2 is a diagram illustrating another processing system according to an embodiment of the present invention. The major difference between the processing systems 100 and 200 is that the SoC 204 implemented in the processing system 200. The SoC 204 may include a DMA controller 210 coupled between the local memory device 134 and the external memory device 128. The external memory device 128 can be any memory device external to the keyword recognition sub-system 124, any memory device different from the local memory device 134, and/or any memory device not directly accessible to the processor 132. For example, the external memory device 128 may be a main memory (e.g., a dynamic random access memory (DRAM)) accessible to the main processor 126 (e.g., an application processor (AP)). The local memory device 134 may be located inside or outside the processor 132. As mentioned above, the local memory device 134 may be arranged to buffer one or both of data needed by a keyword recognition function and data needed by an application (e.g., audio recording application or voice assistant application). In this embodiment, the DMA controller 210 may be arranged to perform DMA data transaction between the local memory device 134 and the external memory device 128. Due to inherent characteristics of the DMA controller 210, none of the processor 132 and the main processor 126 may be involved in the DMA data transaction between the local memory device 134 and the external memory device 128. Hence, the power consumption of data transaction between the local memory device 134 and the external memory device 128 can be reduced. Since the DMA controller 210 may be able to deal with data transaction between the local memory device 134 and the external memory device 128, the local memory device 134 may be configured to have a smaller memory size. Hence, the hardware cost can be reduced. Further details of the processing system 200 are described as below.

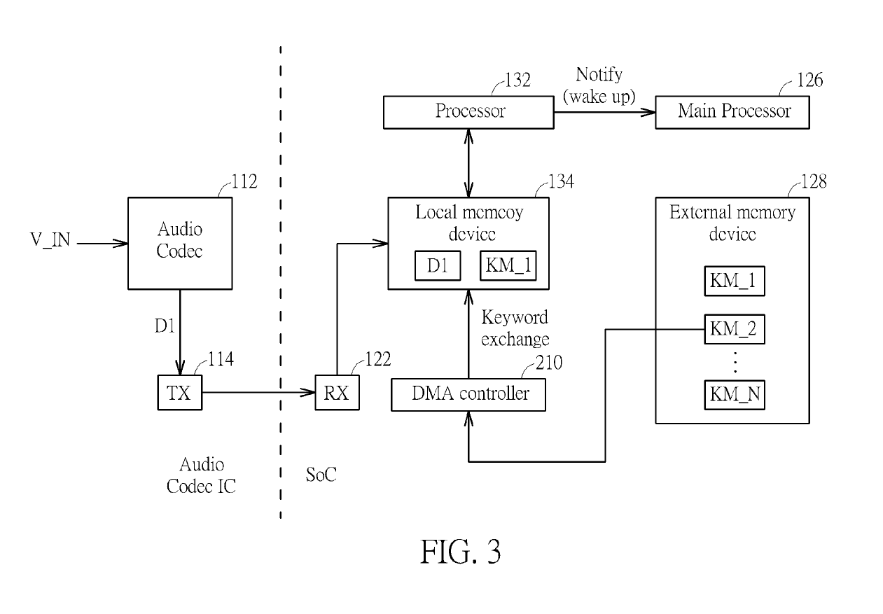

FIG. 3 is a diagram illustrating an operational scenario in which the keyword recognition sub-system 124 in FIG. 2 may be configured to achieve multi-keyword recognition according to an embodiment of the present invention. As mentioned above, the data needed by the multi-keyword recognition may include an audio data D1 derived from the voice input V_IN and an auxiliary data not derived from the voice input V_IN (e.g., a plurality of keyword models KM_1-KM_N involved in the multi-keyword recognition). At least a portion (e.g., part or all) of the keyword models KM_1-KM_N needed by the multi-keyword recognition may be held in the same external memory device (e.g., DRAM) 128, as shown in FIG. 3. To perform the multi-keyword recognition, the audio data D1 and one keyword model KM_1 may be buffered in the local memory device 134. For example, the keyword model KM_1 may be loaded into the local memory device 134 from the external memory device 128 via the DMA data transaction managed by the DMA controller 210. Hence, the processor 132 may compare the audio data D1 with the keyword model KM_1 to determine if the audio data D1 may contain a keyword defined in the keyword model KM_1. For example, the processor 132 may notify (e.g., wake up) the main processor 126 upon detecting a pre-defined keyword in the audio data D1.

The DMA controller 210 may be operative to load another keyword model KM_2 (which is different from the keyword model KM_1) into the local memory device 134 from the external memory device 128 via the DMA data transaction, where an old keyword model (e.g., KM_1) in the local memory device 134 may be replaced by a new keyword model (e.g., KM_2) read from the external memory device 128 due to keyword model exchange for the multi-keyword recognition. Similarly, the processor 132 may compare the same audio data D1 with the keyword model KM_2 to determine if the audio data D1 may contain a keyword defined in the keyword model KM_2. For example, the processor 132 may notify (e.g., wake up) the main processor 126 upon detecting a pre-defined keyword in the audio data D1.

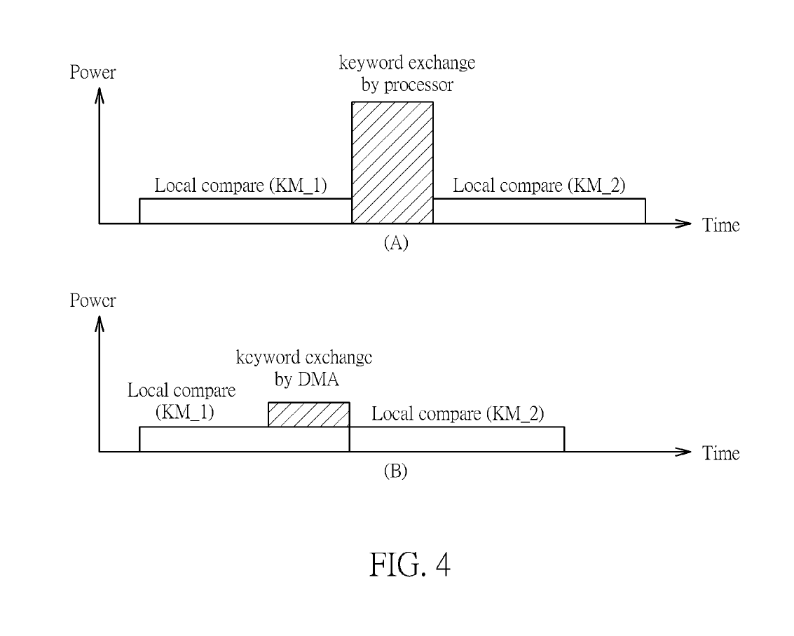

In this embodiment, the keyword model exchange for multi-keyword recognition is accomplished by the DMA controller 210 rather than a processor (e.g., 132 or 126). Hence, the power consumption of the keyword model exchange can be reduced, and the efficiency of the keyword recognition can be improved. FIG. 4 is a diagram illustrating a comparison between keyword recognition with processor-based keyword model exchange and keyword recognition with DMA-based keyword model exchange according to an embodiment of the present invention. Power consumption of the keyword recognition with processor-based keyword model exchange may be illustrated in sub-diagram (A) of FIG. 4, and power consumption of the keyword recognition with DMA-based keyword model exchange may be illustrated in sub-diagram (B) of FIG. 4. As the keyword exchange performed by the DMA controller 210 may need no intervention of a processor (e.g., processor 132), the efficiency of the keyword recognition may not be degraded. Further, compared to the power consumption of the keyword model exchange performed by the processor (e.g., processor 132), the power consumption of the keyword model exchange performed by the DMA controller 210 may be lower.

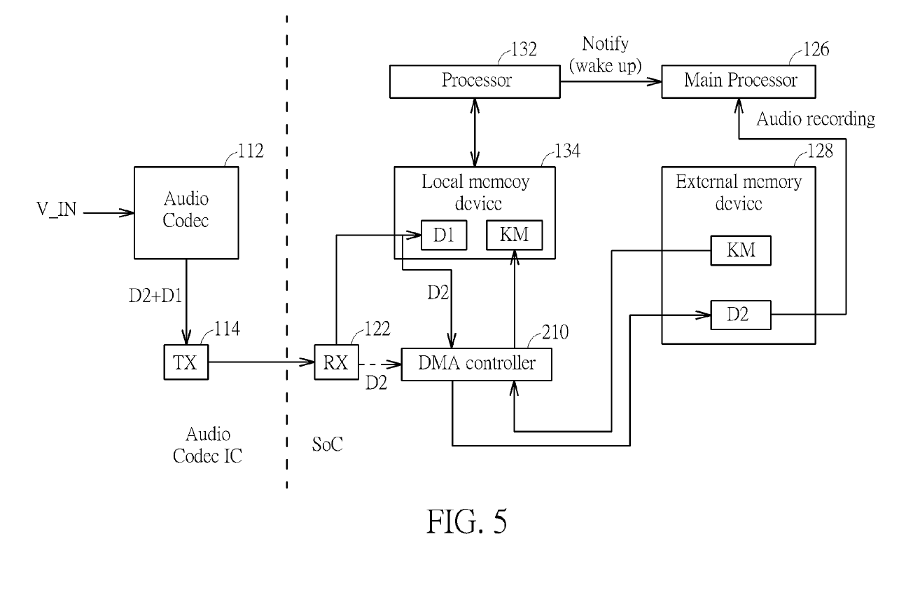

FIG. 5 is a diagram illustrating an operational scenario in which the keyword recognition sub-system 124 in FIG. 2 may be configured to achieve concurrent application use (e.g., performing audio recording and keyword recognition concurrently, performing audio playback and keyword recognition concurrently, performing phone call and keyword recognition concurrently, and/or performing VoIP and keyword recognition concurrently) according to an embodiment of the present invention. As mentioned above, the data needed by the keyword recognition running on the processor 132 may include an audio data D1 derived from the voice input V_IN and an auxiliary data not derived from the voice input V_IN (e.g., at least one keyword model KM), and the data needed by an audio recording application running on the main processor 126 may include another audio data D2 derived from the same voice input V_IN, where the audio data D2 may follow the audio data D1. For example, a user may speak a keyword and then may keep talking. The spoken keyword may be required to be recognized by the keyword recognition function for launching the audio recording application, and the subsequent speech content may be required to be recorded by the launched audio recording application.

To perform the keyword recognition, the audio data D1 and the keyword model KM may be buffered in the local memory device 134. For example, the keyword model KM may be loaded into the local memory device 134 from the external memory device 128 via the DMA data transaction managed by the DMA controller 210. In this example, a single-keyword recognition operation may be enabled. However, this is for illustrative purposes only, and is not meant to be a limitation of the present invention. Alternatively, the aforementioned multi-keyword recognition shown in FIG. 3 may be employed, where the keyword model exchange may be performed by the DMA controller 210. In this example, the processor 132 may compare the audio data D1 with the keyword model KM to determine if the audio data D1 may contain a keyword defined in the keyword model KM. For example, the processor 132 may notify (e.g., wake up) the main processor 126 upon detecting a pre-defined keyword in the audio data D1.

With regard to the audio data D2 subsequent to the audio data D1, pieces of the audio data D2 may be stored into the local memory device 134 one by one, and the DMA controller 210 may transfer each of the pieces of the audio data D2 from the local memory device 134 to the external memory device 128 via DMA data transaction. Alternatively, pieces of the audio data D2 may be transferred from the RX circuit 122 to the DMA controller 210 one by one without entering the local memory device 134, and the DMA controller 210 may transfer pieces of the audio data D2 received from the RX circuit 122 to the external memory device 128 via DMA data transaction. At the same time, the processor 132 may perform keyword recognition based on the audio data D1 and the keyword model KM. The processor 132 may refer to a keyword recognition result generated for the audio data D1 to selectively notify (e.g., wake up) the main processor 126 to perform audio recording upon the audio data D2 buffered in the external memory device 128.

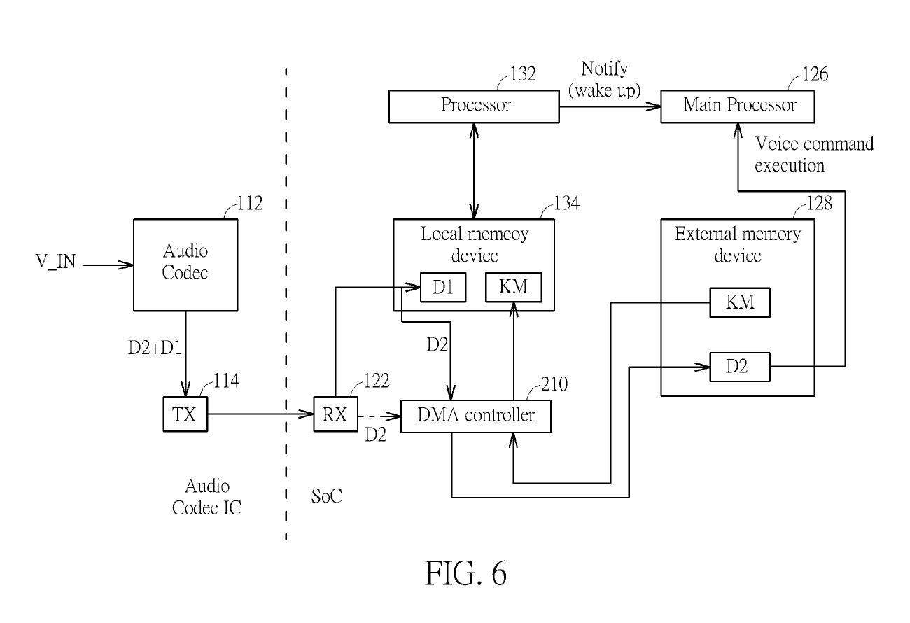

FIG. 6 is a diagram illustrating an operational scenario in which the keyword recognition sub-system 124 in FIG. 2 may be configured to achieve continuous voice command according to an embodiment of the present invention. As mentioned above, the data needed by the keyword recognition running on the processor 132 may include an audio data D1 derived from the voice input V_IN and an auxiliary data not derived from the voice input V_IN (e.g., at least one keyword model KM), and the data needed by an audio assistant application running on the main processor 126 may include another audio data D2 derived from the same voice input V_IN, where the audio data D2 may follow the audio data D1. For example, a user may speak a keyword and then may keep speaking at least one voice command. The spoken keyword may be required to be recognized by the keyword recognition function for launching a voice assistant application, and the subsequent voice command(s) may be required to be handled by the launched voice assistant application.

To perform the keyword recognition, the audio data D1 and the keyword model KM may be buffered in the local memory device 134. For example, the keyword model KM may be loaded into the local memory device 134 from the external memory device 128 via the DMA data transaction managed by the DMA controller 210. In this example, a single-keyword recognition operation may be enabled. However, this is for illustrative purposes only, and is not meant to be a limitation of the present invention. Alternatively, the aforementioned multi-keyword recognition shown in FIG. 3 may be employed, where the keyword model exchange may be performed by the DMA controller 210. In this example, the processor 132 may compare the audio data D1 with the keyword model KM to determine if the audio data D1 may contain a keyword defined in the keyword model KM. For example, the processor 132 may notify (e.g., wake up) the main processor 126 upon detecting a pre-defined keyword in the audio data D1.

With regard to the audio data D2 subsequent to the audio data D1, pieces of the audio data D2 may be stored into the local memory device 134 one by one, and the DMA controller 210 may transfer each of the pieces of the audio data D2 from the local memory device 134 to the external memory device 128 via DMA data transaction. Alternatively, pieces of the audio data D2 may be transferred from the RX circuit 122 to the DMA controller 210 one by one without entering the local memory device 134, and the DMA controller 210 may transfer pieces of the audio data D2 received from the RX circuit 122 to the external memory device 128 via DMA data transaction. At the same time, the processor 132 may perform keyword recognition based on the audio data D1 and the keyword model KM. The processor 132 may refer to a keyword recognition result generated for the audio data D1 to selectively notify (e.g., wake up) the main processor 126 to perform voice command execution based on the audio data D2 (which may include at least one voice command) buffered in the external memory device 128.

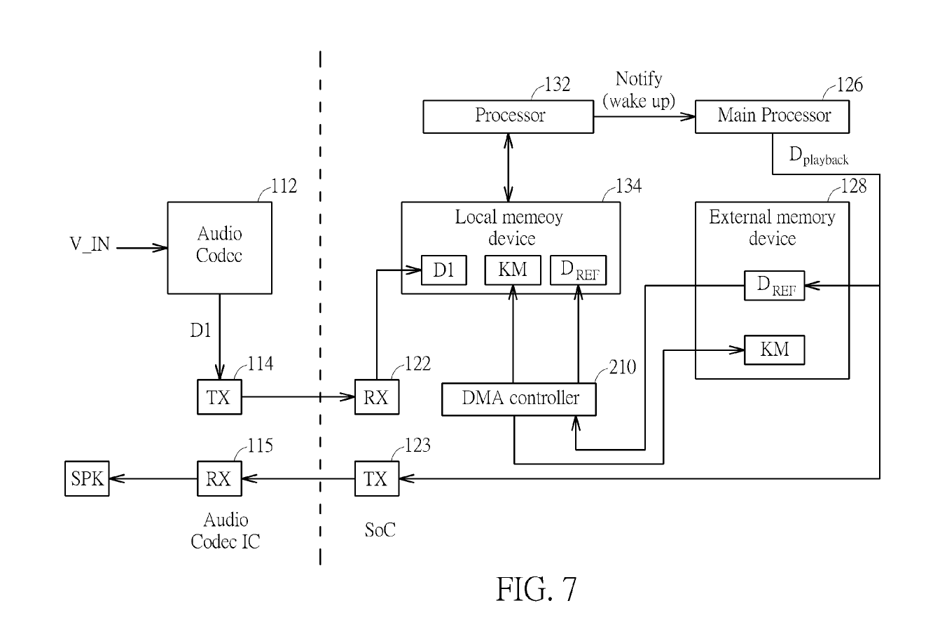

FIG. 7 is a diagram illustrating an operational scenario in which the keyword recognition sub-system 124 in FIG. 2 may be configured to achieve keyword recognition with echo cancellation according to an embodiment of the present invention. As mentioned above, the data needed by keyword recognition with echo cancellation may include an audio data D1 derived from the voice input V_IN and an auxiliary data not derived from the voice input V_IN (e.g., at least one keyword model KM and one echo reference data D_{REF} involved in the keyword recognition with echo cancellation). For example, the echo cancellation may be enabled when the main processor 126 may be currently running an audio playback application. Hence, an audio playback data D_{playback} may be generated from the main processor 126 and transmitted from the SoC 204 to the audio Codec IC 102 for driving the external speaker SPK connected to the audio Codec IC 102. The main processor 126 may also store the audio playback data D_{playback} into the external memory device 128, directly or indirectly, to serve as the echo reference data D_{REF} needed by echo cancellation. In this embodiment, the operation of storing the audio playback data D_{playback} into the external memory device 128 may be performed in a direct manner or an indirect manner, depending upon actual design considerations. For example, when the direct manner may be selected, the echo reference data D_{REF} stored in the external memory device 128 may be exactly the same as the audio playback data D_{playback}. For another example, when the indirect manner may be selected, the operation of storing the audio playback data D_{playback} into the external memory device 128 may include certain audio data processing such as format conversion used to adjust, for example, a sampling rate and/or bits/channels per sample. Hence, the echo reference data D_{REF} stored in the external memory device 128 may be a format conversion result of the audio playback data D_{playback}.

To perform the keyword recognition with echo cancellation, the audio data D1, the keyword model KM and the echo reference data D_{REF} may be buffered in the local memory device 134. For example, the keyword model KM may be loaded into the local memory device 134 from the external memory device 128 via the DMA data transaction managed by the DMA controller 210. In this example, a single-keyword recognition operation may be enabled. However, this is for illustrative purposes only, and is not meant to be a limitation of the present invention. Alternatively, the aforementioned multi-keyword recognition shown in FIG. 3 may be employed, where the keyword model exchange may be performed by the DMA controller 210.

Further, the echo reference data D_{REF} may be loaded into the local memory device 134 from the external memory device 128 via the DMA data transaction managed by the DMA controller 210. During the audio playback process, the main processor 126 may keep writing new audio playback data D_{playback} into the external memory device 128, directly or indirectly, to serve as new echo reference data D_{REF} needed by echo cancellation. In this embodiment, the DMA controller 210 may be configured to periodically transfer new echo reference data D_{REF} from the external memory device 128 to the local memory device 134 to update old echo reference data D_{REF} buffered in the local memory device 134. In this way, the latest echo reference data D_{REF} may be available in the local memory device 134 for echo cancellation. However, this is for illustrative purposes only, and is not meant to be a limitation of the present invention.

In one exemplary design, the echo reference data D_{REF} may not be used to remove echo interference from the audio data D1 before the audio data D1 is compared with the keyword model KM. Hence, the processor 132 may refer to the echo reference data D_{REF} buffered in the local memory device 134 to compare the audio data D1 with the keyword model KM also buffered in the local memory device 134 for determining if the audio data D1 may contain a keyword defined in the keyword model KM. That is, when comparing the audio data D1 with the keyword model KM, the processor 132 may perform keyword recognition assisted by the echo reference data D_{REF}. In another exemplary design, the processor 132 may refer to the echo reference data D_{REF} to remove echo interference from the audio data D1 before comparing the audio data D1 with the keyword model KM. Hence, the processor 132 may perform keyword recognition by comparing the echo-cancelled audio data D1 with the keyword model KM. However, these are for illustrative purposes only, and are not meant to be limitations of the present invention.

The processor 132 may refer to a keyword recognition result generated for the audio data D1 to selectively notify the main processor 126 to perform action associated with the recognized keyword. For example, when the voice input V_IN may be captured by a microphone under a condition that the audio playback data D_{playback} may be played via the external speaker SPK at the same time, the processor 132 may enable keyword recognition with echo cancellation to mitigate interference caused by concurrent audio playback, and may notify the main processor 126 to launch a voice assistant application upon detecting a pre-defined keyword in the audio data D1. Since the present invention focuses on data transaction of the echo reference data rather than implementation of the echo cancellation algorithm, further details of the echo cancellation algorithm are omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A processing system comprising:
a keyword recognition sub-system comprising:
a processor, arranged to perform at least keyword recognition; and
a local memory device, accessible to the processor, wherein the local memory device is arranged to buffer at least data needed by the keyword recognition; and
a direct memory access (DMA) controller, interfacing between the local memory device of the keyword recognition sub-system and an external memory device, wherein the DMA controller is arranged to perform DMA data transaction between the local memory device and the external memory device.

2. The processing system of claim 1, wherein the data needed by the keyword recognition comprises a first keyword model loaded into the local memory device from the external memory device via the DMA data transaction.

3. The processing system of claim 2, wherein the keyword recognition is multi-keyword recognition; and the data needed by the keyword recognition further comprises a second keyword model that is different from the first keyword model and is replaced by the first keyword model due to keyword model exchange for the multi-keyword recognition.

4. The processing system of claim 2, wherein the data needed by the keyword recognition further comprises an audio data derived from a voice input; and the processor is further arranged to refer to a keyword recognition result generated according to the first keyword model and the audio data to selectively notify a main processor.

5. The processing system of claim 1, wherein the data needed by the keyword recognition comprises a first audio data derived from a voice input; and a second audio data following the first audio data is derived from the voice input, and is transferred to the external memory device via the DMA data transaction.

6. The processing system of claim 5, wherein the processor is further arranged to refer to a keyword recognition result generated for the first audio data to selectively notify a main processor to perform audio recording upon the second audio data.

7. The processing system of claim 5, wherein the second audio data comprises at least one voice command; and the processor is further arranged to refer to a keyword recognition result generated for the first audio data to selectively notify a main processor to deal with the at least one voice command.

8. The processing system of claim 1, wherein the processor is arranged to perform the keyword recognition with echo cancellation; and the data needed by the keyword recognition comprises an echo reference data loaded into the local memory device from the external memory device via the DMA data transaction.

9. A processing system comprising:
a keyword recognition sub-system comprising:
a processor, arranged to perform at least keyword recognition; and
a local memory device, accessible to the processor, wherein the local memory device is arranged to buffer data needed by the keyword recognition and data needed by an application.

10. The processing system of claim 9, wherein there is no direct memory access (DMA) data transaction between the local memory device and an external memory device.

11. The processing system of claim 9, wherein the local memory device is arranged to buffer the data needed by the keyword recognition and the data needed by the application at a same time.

12. The processing system of claim 9, wherein the data needed by the keyword recognition comprises a first audio data derived from a voice input, and the data needed by the application comprises a second audio data derived from the voice input, the second audio data follows the first audio data; and the processor is further arranged to refer to a keyword recognition result generated for the first audio data to selectively notify a main processor to perform audio recording upon the second audio data.

13. The processing system of claim 9, wherein the data needed by the keyword recognition comprises a first audio data derived from a voice input, and the data needed by the application comprises a second audio data derived from the voice input, the second audio data follows the first audio data and comprises at least one voice command; and the processor is further arranged to refer to a keyword recognition result generated for the first audio data to selectively notify a main processor to deal with the at least one voice command.

14. The processing system of claim 9, wherein during the keyword recognition being performed by the processor, the processor is further arranged to notify a main processor to deal with a least a portion of one of the data needed by the keyword recognition and the data needed by the application.

15. The processing system of claim 14, wherein the keyword recognition is multi-keyword recognition, and during the keyword recognition being performed by the processor, the processor notifies the main processor to deal with keyword model exchange for the multi-keyword recognition.

16. The processing system of claim 14, wherein the data needed by the keyword recognition comprises a first audio data derived from a voice input; the data needed by the application comprises a second audio data derived from the voice input, where the second audio data follows the first audio data; and during the keyword recognition being performed by the processor, the processor notifies the main processor to capture the second audio data for audio recording.

17. The processing system of claim 14, wherein the data needed by the keyword recognition comprises a first audio data derived from a voice input; the data needed by the application comprises a second audio data derived from the voice input, where the second audio data follows the first audio data and comprises at least one voice command; and during the keyword recognition being performed by the processor, the processor notifies the main processor to capture the second audio data for voice command execution.

18. The processing system of claim 14, wherein the processor is arranged to perform the keyword recognition with echo cancellation; the data needed by the keyword recognition comprises an echo reference data; and during the keyword recognition being performed by the processor, the processor notifies the main processor to write the echo reference data into the local memory device.

19. The processing system of claim 9, wherein during the keyword recognition being performed by the processor, the processor is further arranged to access an external memory device to deal with at least a portion of one of the data needed by the keyword recognition and the data needed by the application.

20. The processing system of claim 19, wherein the keyword recognition is multi-keyword recognition, and during the keyword recognition being performed by the processor, the processor accesses the external memory device to deal with keyword model exchange for the multi-keyword recognition.

21. The processing system of claim 19, wherein the data needed by the keyword recognition comprises a first audio data derived from a voice input; the data needed by the application comprises a second audio data derived from the voice input, where the second audio data follows the first audio data; and during the keyword recognition being performed by the processor, the processor writes the second audio data into the external memory device for audio recording.

22. The processing system of claim 19, wherein the data needed by the keyword recognition comprises a first audio data derived from a voice input; the data needed by the application comprises a second audio data derived from the voice input, where the second audio data follows the first audio data and comprises at least one voice command; and during the keyword recognition being performed by the processor, the processor writes the second audio data into the external memory device for voice command execution.

23. The processing system of claim 19, wherein the processor is arranged to perform the keyword recognition with echo cancellation; the data needed by the keyword recognition comprises an echo reference data; and during the keyword recognition being performed by the processor, the processor fetches the echo reference data from the external memory device.
